(19) United States
(12) Patent Application Publication
(10) Pub. No.: US 2003/0080866 A1
(43) Pub. Date: May 1, 2003

(54) Doubled sided pen module

(75) Inventor: George Marmaropoulos, Thessaloniki (GR)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/043,381

(22) Filed: Oct. 26, 2001

(51) Int. Cl. G08B 21/00

(52) U.S. Cl. 340/540; 340/693.9

(57) ABSTRACT

Pen-shaped modules of the type widely used by health care personnel and other workers in sensitive environments, are provided with two separate pocket clips positioned in opposed spaced-apart relationship. Markings associated with each clip clearly identify one clip as “ON” and the other clip as “OFF”. At least one of the clips performs electrical switching functions so that when the “ON” clip is fastened to the fabric of a wearer's garment, the electronic module is activated; that is, the module is turned “on”. In the alternative, when the “OFF” clip is attached to the wearer's garment, the electronic components of the module are deactivated; that is, the module is turned “off”.

### BACKGROUND OF THE INVENTION

1. Field of the Invention

This invention relates generally to pen-type electronic modules of the type commonly worn by health care workers, and more particularly relates to modules of this type that are automatically turned “on” or “off” by affixing them to the garment of a wearer in a particular orientation.

2. Description of the Invention

Pen-type electronic modules have become relatively widely used by health care workers and other workers exposed to dangerous or otherwise sensitive environments, during the 1990's. The modules are, in effect, miniaturized environmental sensors that are worn by workers to warn them of significant surrounding environmental conditions, such as temperature, air pollution, radiation levels, etc. All of the modules in use to date generally rely on manual operation of an electrical switch device to turn the module “on” and “off”; that is, to activate or deactivate operation of the module. Users of such modules often overlook, for various reasons, the need to activate the module when they attach it to their garment, thereby depriving themselves, as well as their supervisors and other affected personnel, of the protection for which the module is intended. Alternately, many users forget to turn the module off when they remove it from their garment at the end of a wearing period, thereby running down the battery and/or rendering the module inoperative for the next use. The present invention addresses and eliminates these existing problems of pen-type modules, by providing a module that can be secured to the garment of a wearer in either one of two positions; in one position, the module remains in its off condition; in the other position, the electronic circuits of the module are automatically turned on.

### SUMMARY OF THE INVENTION

In the disclosed embodiment of the invention, the apparatus of the module includes two different pocket or garment clips members to secure the module to the garment of a wearer/user in either one of two different positions. Electrical switch means associated with at least one of the clips turns the module on when that clip is used, and the module is automatically turned off when the other clip is used. Visible indicia, such as “ON” and “OFF” signs are associated with each clip to provide clear indications of the current condition of the module.

The circuitry of the module incorporates a normally-closed switch that maintains the module in the “off” condition until the switch is opened; opening the circuit associated with the switch automatically turns the module “on”, causing it to operate for its intended purpose. The switch incorporates the resilient pocket clip element as a conductor in the “on-off” circuit; the clip resiliently engages an opposed, conductive surface on the main body of the module to complete the circuit. When a portion of the fabric of the wearer's garment, such as the edge of a pocket in which the module is received, is interposed between the clip and the opposed conductive surface, the circuit is interrupted, and the module is turned “on”. This clip preferably may be associated with printed indicia, positioned to be visible outside of the pocket in which the module is received, indicating that the module is in the “on” condition. Alternatively, if the module is engaged in the garment pocket using the other of the two pocket clips, the “on-off” circuit remains uninterrupted and the module remains in the “off” condition. Similarly, printed indicia associated with this second clip, may be associated with printed indicating the “off” condition of the module.

These and other and further features and advantages of this invention will be made more apparent to those having skill in this art, by reference to the following specification considered in conjunction with the accompanying drawings, in which:

### BRIEF DESCRIPTION OF THE DRAWINGS

FIG. 1 is a pictorial representation showing how pen-type modules may be used in accordance with this invention;

FIG. 2 is a front plan view of a pen module in accordance with this invention;

FIG. 3 is a side elevation view of the pen module of FIG. 2;

FIG. 4 is a partial side elevation view of the pen module of FIG. 2; and,

FIG. 5 is a partial side elevation view of a modified embodiment of this invention.

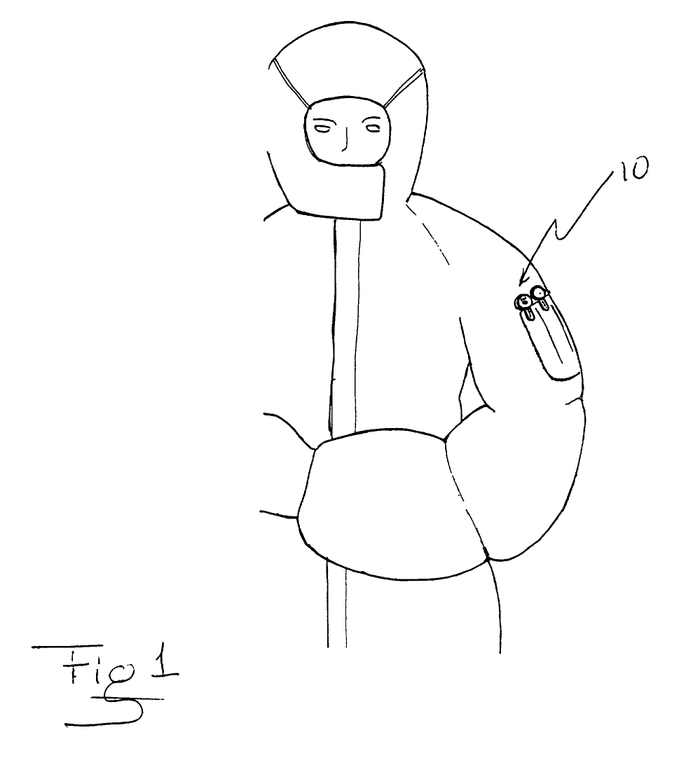

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. For purposes of simplicity and clarity, detailed descriptions of well-known devices, circuits, and methods are omitted so as not to obscure the description of the present invention with unnecessary detail.

Referring now more specifically to the drawings, the pen-type module 10 of this invention can be seen to comprise a main body structure 12 having an indicator or sensor portion 14 and a pair of resilient pocket clip elements 16, 18 arrayed in opposed, spaced apart locations. In this embodiment the opposed locations for clip elements 16, 18 are on opposite sides of the main body structure 12. In accordance with the structure of conventional pocket clips used on conventional pocket pens, each clip 16, 18 has a fixed end 20 and a free end 22.

The fixed end 20 of each clip is attached to main body structure 12, either directly, or indirectly as through sensor portion 14. Free end 22 of each clip 16, 18 is resiliently biased against the surface of main body structure 12 so as to securely but releasably grip a planar material, such as a portion 19 of garment fabric, between the free end 22 and the surface of the body structure 12. For this purpose, clips 16, 18 may be made of a resiliently flexible material with fixed end 20 securely attached to body 12 so that free end 22 is biased against the surface of body 12 by the resilience of the clip structure. Alternatively, clips 16, 18 may be made of a more rigid material and fixed end 20 may be resiliently coupled to body 12 to achieve the desired resilient biasing of free end 22 toward body 12.

In accordance with this invention, the resiliently flexible material of at least one of clips 16, 18, is electrically conductive, and at least a portion 24 of the surface of body 12 that is engaged by free end 22 of that clip is also electrically conductive. In the illustrated embodiment, clip 18 is made to be conductive, so that a continuous electrical path is established between conductive portion 24 and clip 18 when they are in contact with each other. Further in accordance with this invention, clip 18 is mounted to body 12 in such manner that it is electrically insulated from body 12, and accordingly, the only electrical contact between body 12 and clip 18 is at the interface of free end 22 and conductive surface portion 24. Conductive surface portion 24 and free end 22 of clip 18 are separated from electrical contact with each other when an electrically insulating barrier, such as a portion of garment fabric, is positioned between them. It will be understood readily by those having ordinary skill in this art, that in the process of using clip 18 to secure the associated pen module to the garment of a wearer, a portion of the garment fabric will be inserted between free end 22 and conductive portion 24 of body 12, to secure the associated pen module to the wearer's garment.

Still further in accordance with this invention, the internal electronic structure of the module is established in any conventional manner so that the continuous electrical circuit created by electrical engagement of contact surface 24 with free end 22 of clip 18, maintains the electronic functions of the module in the “off” condition; that is, the module is not in operating mode. And accordingly, when the electrical path through contact 24 and free end 20 is interrupted, as by the insertion of a piece of garment fabric between the two, the status of the module “switches” to the “on” condition. In this manner, automatic on-off operation is of module 10 achieved, the module being maintained in its “off” condition when the circuit path through contact 24 and clip 18 is compete because clip 18 is not attached to a portion of fabric, and the module being switched to its “on” condition automatically when the circuit path is interrupted because clip 18 is in use with a piece of fabric engaged between its opposed gripping/contacting surfaces.

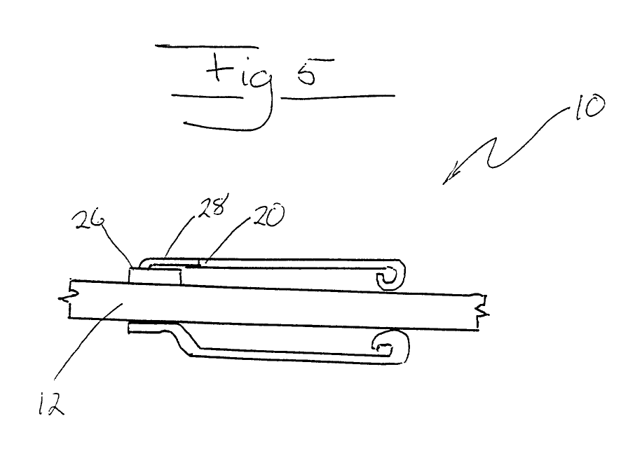

An alternative embodiment of the invention is shown in FIG. 5, in which fixed end 20 of clip 18 is not fixedly attached to body 12, but rather is coupled to the lever actuator arm 28 of a conventional normally-closed lever-action electrical switch 26 that is, in turn, mounted to body 12. In this embodiment, the conventional resilient closing mechanism of switch 26 serves as the resilient bias means for urging the free end 22 of clip 18 into gripping engagement with body 12. The displacement of clip 18 caused by interposing a portion of garment fabric between free end 22 and the surface of body 12, activates the switch 26 and alters its condition from “closed” to “open” thereby interrupting the circuit controlled by the switch. In this manner switch 26 operates in the same manner and for the same purpose as the electrical path formed by clip 18 and contact 24 in the embodiment of FIG. 4. Specifically, interposing a section of fabric between free end 24 and body 12, to grip the fabric and secure the module 10 to a wearer's garment, displaces clip 18 and opens switch 26 to which the clip is attached, thereby interrupting the circuit coupled to the switch so as to change the condition of the module from “off” to “on”.

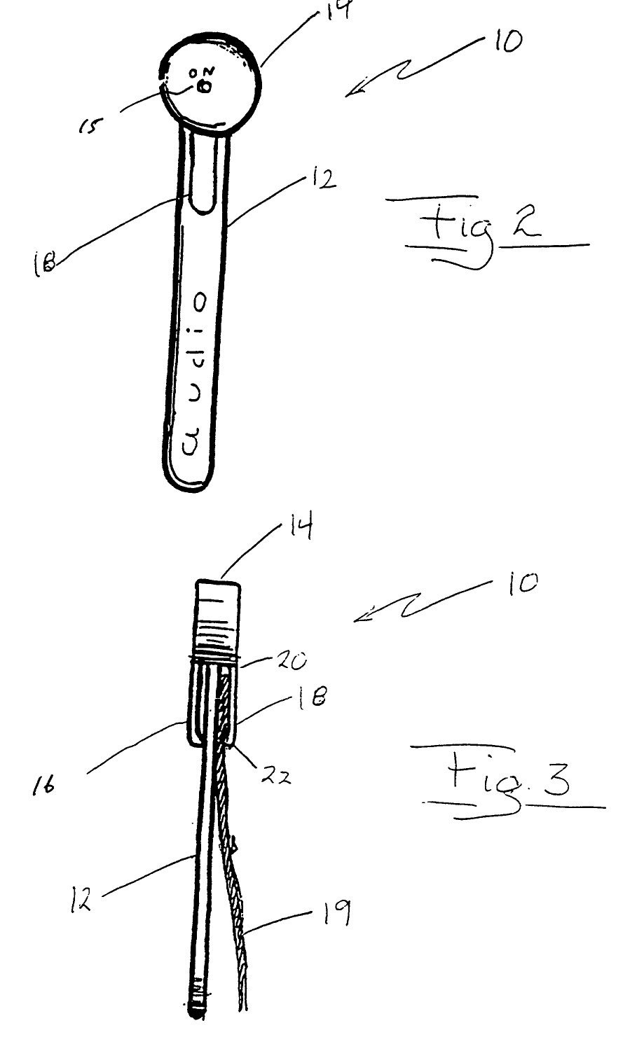

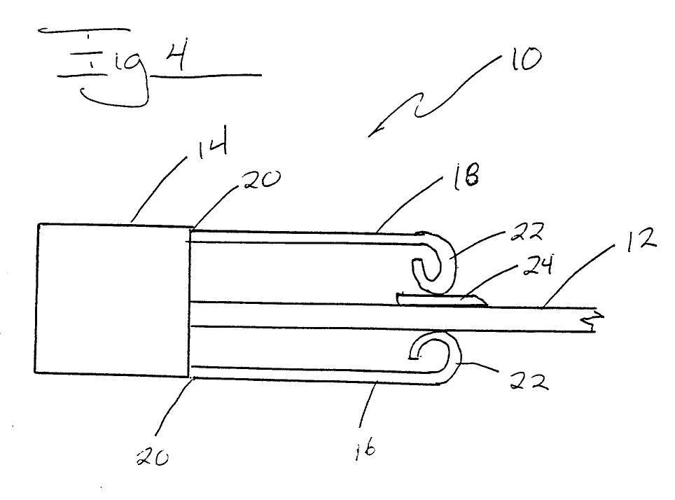

To further facilitate use of the invention, clips 16, 18 preferably are used in conjunction with visible indicia 15, such as shown at reference numeral 15 in FIG. 2, identifying the function associated with the corresponding clip. As an example only, the words “ON” and “OFF” may be printed in prominent type face directly on or nearby each clip as identified by reference numerals 15 and 17 in FIG. 3, so that potential users can determine readily how to orient the module so that it will perform the desired function when it is being attached to the wearer's garment, and an outside observer can similarly determine if the module is being worn by another in proper orientation to function in an appropriate manner.

Now, it should be obvious to those having skill in this art that the wearable module of this invention will function, readily, to be turned on or off readily and automatically upon being attached to the garment of a wearer, without reference to manipulation or positioning of manual switches, and will remain in the proper function mode so long as it is worn, without concern about inadvertent operation of a manual switch.

Although a preferred embodiment of the invention has been illustrated and described, it will be obvious to those having skill in this art that various other forms and embodiments of the invention now may be visualized, readily, by those having skill in this art, without departing substantially from the spirit and scope of the invention set forth in the accompanying claims.

What is claimed is:

1. A pen-type electronic module comprising:
a main body structure;
a first pocket clip and a second pocket clip arrayed in opposed, spaced apart locations on said main body structure, each having a free end and a fixed end;
said fixed end of each pocket clip being mounted to said main body structure, and said fee end being resiliently biased into contact with said main body structure;
said free end of each pocket clip being resiliently displaceable from a first position in contact with said main body structure, to a second position separated from contact with said main body structure;
on-off electrical switching means associated with at least one of said pocket clips; and,
said electrical switching means being activatable to switch between an on condition and an off condition in response to displacement of said free end of the associated one of said pocket clips between said first position and said second position.

2. A pen-type electronic module in accordance with claim 1, wherein said on-off electronic switching means comprises a first electrical contact surface at said free end of said one of said pocket clips and a second, electrical contact surface on said main body structure, said first and second electrical contact surfaces being in electrical contact with each other when said free end of said one of said pocket clips is in said first position.

3. A pen-type electronic module in accordance with claim 2, further comprising visible indicia associated with each of said pocket clips identifying the condition of the module corresponding to use of the related pocket clip.

4. A pen-type electronic module in accordance with claim 1, wherein said on-off electronic switching means comprises a normally-closed lever-action electrical switch having a lever actuator arm and resilient means biasing the actuator arm to the said closed condition; and,
said electrical switch being mounted to said main body structure, and said fixed end of said clip being mounted to said lever actuator arm for biasing said free end of said clip into said first position against said body structure.

5. A pen-type electronic module in accordance with claim 1, wherein said on-off switching means is normally closed when said free end of the said one of said pocket clips is in said first position and said electronic module is turned on when said switching means is normally closed.

6. A method for effective sensing of ambient conditions around a person using a two-sided pen-module sensor having a position-responsive clothing clip capable of switching said sensor between on and off conditions, said method comprising:
marking said two-sided pen module sensor with visible indicia indicating “on” on one side thereof, and “off” on the opposite side thereof; and,
clipping said clothing clip to the clothing of said person in the clip position corresponding to the on condition when said “on” indicia is exposed away from said person.
